(19) United States
(12) Patent Application Publication
(10) Pub. No.: US 2014/0336029 A1
(43) Pub. Date: Nov. 13, 2014

(54) PROCESS FOR LASER PUNCTURING HOLES INTO WATER-SOLUBLE FILMS

(71) Applicant: The Procter & Gamble Company, Cincinnati, OH (US)

(72) Inventors: Srinivas Krishnaswamy MIRLE, Liberty Township, OH (US); Thomas Lane Gniewek, St. Louis, MO (US); Zachary ENLOE, St. Louis, MO (US); Darin Reid BROCKMAN, Dayton, KY (US)

(21) Appl. No.: 13/888,604

(22) Filed: May 7, 2013

(51) Int. Cl. B65D 30/22; B23K 26/38

(52) U.S. Cl. CPC B65D 31/12; B23K 26/38
USPC 493/267

(57) ABSTRACT

A process of using lasers having a power of from about 0.5 watts to about 20 watts to puncture holes having maximum widths of about 300 μm in films, more specifically, films used to prepare pouches containing detergent compositions.

### TECHNICAL FIELD

The present invention relates to a process of using lasers having a power of from about 0.5 watts to about 20 watts to puncture holes having a maximum width of about 300 μm in water-soluble films. More specifically, the present invention relates to laser puncturing water-soluble films such as those used to prepare water-soluble pouches containing detergent compositions.

### BACKGROUND OF THE INVENTION

Water-soluble films have been used to prepare pouches containing compositions such as laundry detergents and dishwashing detergents. Examples of such pouches are described in, for example, WO 00/55068.

During the production of such pouches, it is often advantageous to employ puncturing systems to puncture holes in specific regions of water-soluble films. These holes are beneficial in that they allow for the release of gases that may form over time in the powder portions of the pouches. Traditionally, these holes have been created by needle puncturing. Needle puncturing, however, has limitations in regards to the size and uniformity of the holes that can be created in the water-soluble films.

The smallest needles used in such processes generally are only able to puncture holes having widths of 330 μm and larger. In order to prevent powder particles from escaping through the holes, powder particles have to be chosen that have a diameter larger than the diameter of the holes, and that also won't break down to form smaller particles. Loss of powder particles is disadvantageous in that it not only wastes actives, but also contaminates the production lines.

Needles also typically puncture irregularly-shaped holes in the films due to the high speed at which the films are moving in relation to the needles. This problem is exacerbated by the fact that needles tend to wear out over time. These worn down needles work to essentially “tear” the water-soluble films, thus creating even larger holes. To avoid this, frequent replacement of the needles is often needed which adds time and money to the production process.

Therefore, there is a need for a puncturing system that minimizes powder particle loss by puncturing holes that are smaller than the diameter of the smallest powder particles. In addition, there is a need for a puncturing system that punctures holes having a constant shape and size and that does not need to be replaced frequently.

### SUMMARY OF THE INVENTION

There is herein disclosed a process for forming a hole in a film-containing pouch with a laser, the process comprising providing a film; directing a laser beam from a laser to a portion of the film to form a hole having a maximum width of from about 0.5 μm to about 300 μm, the laser having a power of from about 0.5 watts to about 20 watts; and incorporating the film with the hole into a pouch.

There is also disclosed a process for manufacturing a pouch, the process comprising puncturing at least one hole into a film using a laser having a power of from about 0.5 watts to about 20 watts, the laser emitting a laser beam through a lens, the laser beam having a wavelength of from about 3 μm to about 17 μm, and incorporating the film with the at least one hole into a pouch.

There is also a process for manufacturing a pouch comprising the steps of: suctioning a first film into a first cavity and laser puncturing at least one hole into the first film, the laser having a power of from about 0.5 watts to about 20 watts; then adding a powder composition to the first film in the first cavity; then contacting a second film with the first film to form a first compartment; and then sealing the first film and second film together to form a pouch.

### BRIEF DESCRIPTION OF THE DRAWINGS

The detailed description of the drawings particularly refers to the accompanying figures in which:

FIG. 1 is an exemplary view of a laser assembly;

FIG. 2 is an exemplary view of a laser emitting a laser beam through a lens;

FIG. 3 is an exemplary view of a lens having three interlocking elements;

FIGS. 4A and 4B are illustrations of the drum process;

FIG. 5 is a further view of the drum process;

FIG. 6 is an exemplary view of a pouch;

FIG. 7 is prior art showing a needle punctured hole; and

FIG. 8 is a laser punctured hole.

### DETAILED DESCRIPTION

It has been found that lasers having a power of from about 0.5 watts to about 20 watts can be used to puncture smaller and more consistently shaped holes in water-soluble films which can then be formed into water-soluble pouches containing detergent actives. While traditional needle puncturing is able to puncture holes having widths of around 330 μm and larger, it has been found that laser puncturing is able to puncture smaller sized holes having a maximum width of 300 μm or smaller, in another embodiment a maximum width of from about 0.5 μm to about 250 μm, in another embodiment a maximum width of from about 10 μm to about 100 μm, in another embodiment a maximum width of from about 30 μm to about 80 μm. “Maximum width” refers to the measurement of the longest dimension of the hole as measured by a digital microscope. This is significant in that powder particles having smaller sizes are now able to be included in pouches without leaking out during production or storage.

Any sample can be submitted to the digital microscope for maximum width and area measurement. In one embodiment, a strip of laser punctured water-soluble film is placed under the digital microscope; in another embodiment, a fully formed water-soluble pouch is placed under the digital microscope. Any sample size can be submitted, but typically the sample will be no bigger than 15×15 cm. If the film sample is larger than this, the film sample can be cut into separate samples by any suitable technique, and each laser punctured sample measured.

The digital microscope (Zeiss Stemi SV11 Ser. No. 455056; with a Sony Camera 3-CCD (Charge Coupled Device) Model DXC-760MD, Ser. No. 10606) is connected to an interface (ITI-Vision-Itex) that is connected to a computer (CyberPower Windows-7 Professional Ser. No. 152091) that runs Image Pro Plus 7.0 that will do the hole size calculations. Any suitable external light source may be used, for example, Kaiser e-Vision.

The film or pouch sample is placed on black cardboard without stretching or wrinkling. The cardboard with the sample is then placed under the digital microscope and the zoom is adjusted to 3.5 and focused until a clear picture is obtained. Then the sample is removed and the calibration started with the software. The software calibrates using a micrometer scale of 1.0 mm in 0.01 mm divisions (Ted Pella Product Ser. No. CS3692). The software calculates the average greatest hole size in the cross section of the hole, and the open area thereof. The measurement can be repeated twice to obtain three values and an average of the three values is taken as the maximum width and area measurement of the hole.

It has also been found that lasers having a power of from about 0.5 watts to about 20 watts are able to puncture consistently shaped holes in water-soluble films. The hole may be any shape or configuration so long as the maximum width of the hole is 300 μm or smaller. In one embodiment, the hole is substantially circular, in another embodiment the hole is round; in another embodiment the hole is oval; in another embodiment the hole is irregularly shaped. Since lasers do not wear out over time like needles do, they are able to puncture consistently shaped holes into the films without having to be replaced.

While needle puncturing typically punctures holes having an area measurement of about 0.40 mm², laser puncturing is able to puncture holes having an area of from about 0.001 mm² to about 0.2 mm², from about 0.005 mm² to about 0.05 mm², and from about 0.005 mm² to about 0.025 mm², as measured by a digital microscope. In order to achieve one of the benefits of allowing gases to escape from the powder portions of the pouches, the laser punctured holes preferably go through the entire thickness of the water-soluble films.

Processes of Forming Pouches with Laser Puncturing

Pouches may be formed by an all-in-one process in which the compartments of the pouch are formed sequentially, or by a drum process in which the compartments of the pouch are formed simultaneously.

### A. All-in-One Process

In one embodiment, the pouch is formed by an all-in-one process in which the pouch compartments are formed sequentially, meaning either the first compartment is formed before the second compartment, or the second compartment is formed before the first compartment. The all-in-one process comprises a first step of drawing a first film into a cavity to form the bottom portion of a first compartment. The cavity can be any suitable shape such as rectangular, square, circular or oval. The cavity can have any depth; in one embodiment a depth of from about 0.5 cm to about 10 cm, in another embodiment from about 1 cm to about 5 cm. The diameter of the cavity is from about 2 cm to about 15 cm, in another embodiment from about 3 cm to about 10 cm. The diameter is the distance between the two points on the edge of the cavity that are farthest apart.

The first film may be drawn into the cavities by use of any suitable means but, in one embodiment, is drawn in by suction. In one embodiment, the first film is suctioned into the cavity, and then a laser is used to puncture a hole in the first film that corresponds to each individual cavity on the production line. One or more holes may be punctured in the film per individual cavity; in one embodiment, one hole is punctured per cavity. In another embodiment, the lasers are used to puncture holes in the first film before suctioning into the cavities.

Any type of laser known in the art may be used so long as it is able to puncture holes in the films having the desired hole size. One skilled in the art will appreciate the need to adjust the power of the laser so as not to haphazardly “melt” the films instead of merely puncturing holes. One skilled in the art will also appreciate the need to adjust the power of the laser so as not to melt or harm the cavities below the films. In one embodiment, the laser has a power of from about 0.5 watts to about 20 watts; in another embodiment from about 5 watts to about 10 watts. This power of laser is able to consistently puncture the desired hole size without harming either the films or the cavities. In one embodiment, the laser is a CO₂ laser such as the Synrad® 48-1 10 watt laser.

As known to one skilled in the art of lasers, the tip of the laser can be any distance from the top of the film so long as the laser power is adjusted so as not to haphazardly “melt” the water-soluble film or injure the cavities. The tip of the laser refers to the point on the laser where the laser beam is first emitted. In one embodiment, the tip of a 20 watt laser is no closer than 25 mm, in another embodiment no closer than 20 mm, in another embodiment no closer than 15 mm, from the top of the film adjacent to the cavities.

As one skilled in the art of lasers knows, power and wavelength are mathematically related. Any wavelength of lasers may be used so long as it corresponds to the desired power. In one embodiment, the laser has a wavelength of from about 3 μm to about 17 μm, in another embodiment from about 7 μm to about 13 μm, and in another embodiment from about 10.2 μm to about 10.7 μm.

The fastest laser pulse yields the smallest and most circular hole. In one embodiment, the laser has a pulse of from about 400 μs to about 1000 μs, in another embodiment from about 450 μs to about 900 μs, in another embodiment from about 500 μs to about 750 μs, and in another embodiment from about 500 μs to about 600 μs. In one embodiment, the process uses pulse width modulation to pulse the lasers at a rate of 5 kilohertz per second (kHz/s). When the film is moving at a designated processing speed, the laser emits a laser beam at a pulse that is coordinated with the processing speed to form a substantially circular hole.

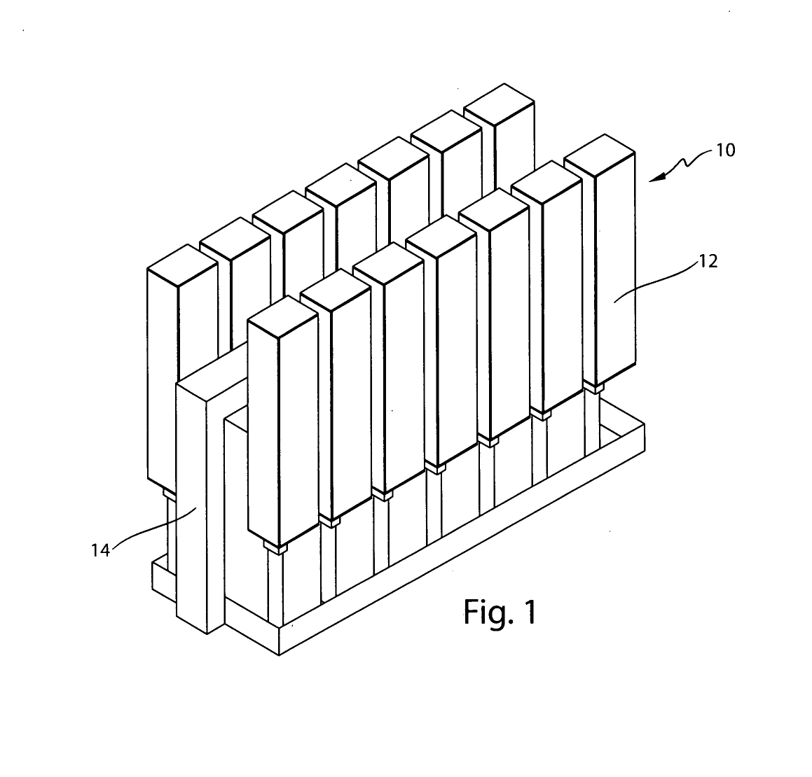

Any configuration of lasers may be used. In one embodiment, a laser assembly is configured to be able to fit into the space occupied by a current needle puncturing system; in another embodiment, the laser assembly is configured to be quickly removed for maintenance. FIG. 1 illustrates one embodiment of a laser assembly 10 in which lasers 12 are mounted on a sliding frame 14 that may be hung above the production line. In another embodiment, single or multiple lasers with galvatron scanning heads are used to puncture multiple lanes of films. In another embodiment, a single laser is mounted on a mechanical assembly that moves the laser directly over the intended puncture areas of the film.

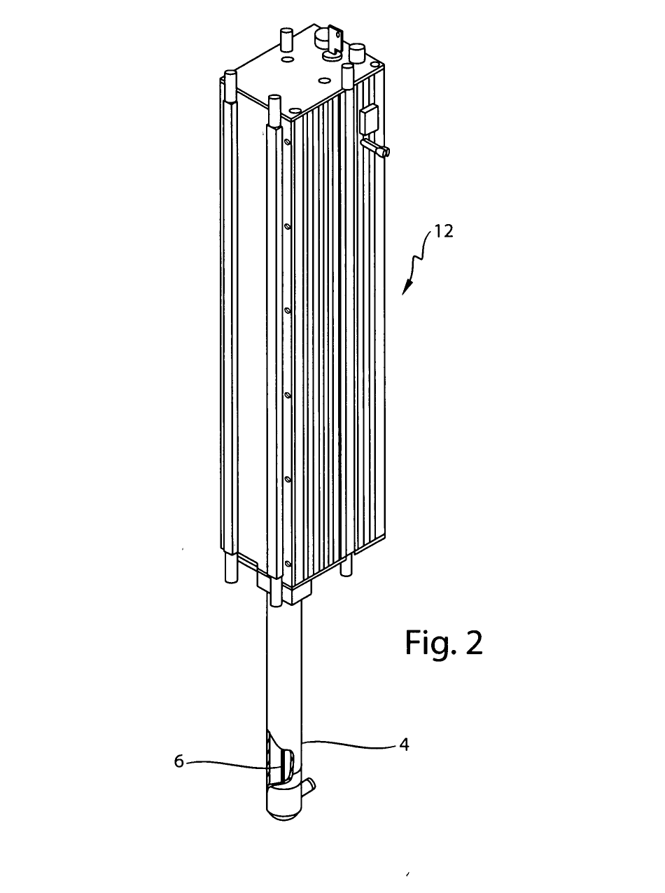

In one embodiment, a laser emitter emits a laser beam through a lens. The lens may protect the laser from damage by small parts or tools used around the production line. The lens can be made of any protective material. In one embodiment, the lens is made of smoked Lexan® (commercial polycarbonate) to prevent leakage of laser radiation; in another embodiment, the lens is made of glass. FIG. 2 shows a laser 12 emitting a laser beam 6 through a lens 4 mounted onto the laser 12. This lens 4 helps to focus and protect the laser beam 6.

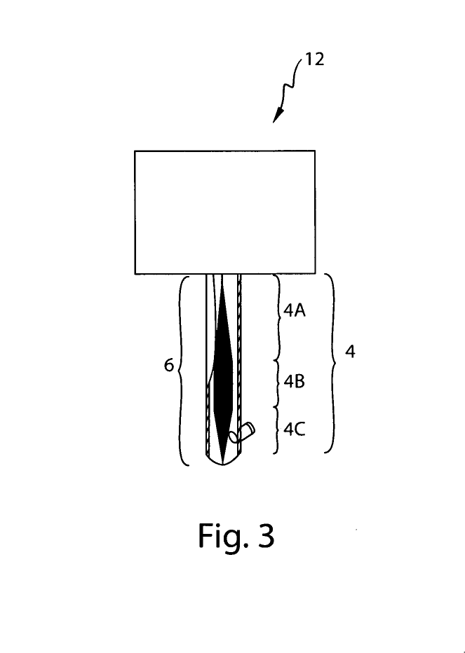

In one embodiment, the lens is a hollow tube. In another embodiment, the lens is made up of at least two interlocking elements, in another embodiment, at least three interlocking elements. FIG. 3 shows a laser 12 emitting a parallel laser beam 6 through a lens 4 having three interlocking elements 4A, 4B, 4C. Element 4A of the lens intercepts the parallel laser beam 6 and expands it. Element 4B of the lens then intercepts the expanding laser beam 6 and returns it to a parallel configuration, albeit a larger parallel beam than the original one. Element 4C of the lens then takes the larger parallel laser beam 6 and focuses it down to a laser beam point that is then used to puncture the film. In one embodiment, the laser beam is focused down to a width of about 0.01 mm after leaving the lens.

In one embodiment, the lens 4 is a hollow tube that partially covers the length of the laser beam 6. In one embodiment the lens is from about 40 mm wide and about 80 mm long, in another embodiment about 55 mm wide and 75 mm long.

In one embodiment, compressed air is blown from an air source into the lens to keep the lens free from contamination during use with the laser beam. In one embodiment, the air source is located below the lens. In one embodiment, air is emitted from a threaded air nozzle. The air has a constant velocity of from about 5 to about 15 meters/minute, in another embodiment from about 10 to about 12 meters/minute.

While needle puncturing typically punctures holes having an area of about 0.40 mm², laser puncturing is able to puncture holes having an area of from about 0.001 mm² to about 0.2 mm², from about 0.005 mm² to about 0.05 mm², and from about 0.005 mm² to about 0.025 mm², as measured by a digital microscope.

After the first film comprising the laser punctured holes is flush with the insides of the cavities, powder compositions are then added to the first film. In one embodiment, from about 10 g to about 100 g, in another embodiment from about 16 g to about 8 g, and in another embodiment from about 20 g to about 70 g, of powder composition is added to the first film.

In the all-in-one process described herein, a second film may then be drawn onto the powder composition to form a first compartment. The second film may be drawn onto the powder composition by use of a suction applied through the laser punctured hole(s) in the first film. This suction creates a low pressure that can be of any suitable strength but may be from about negative 950 to about negative 30 mbar gauge, in another embodiment from about negative 800 to about negative 60 mbar gauge, and in another embodiment from about negative 600 to about negative 90 mbar gauge. This drawing down of the second film can be used to compact the powder compositions in the first cavities. Alternatively mechanical compaction, either by vibration or compression, can be used to compact the powder either pre or post the low pressure being applied to the second film.

This low pressure depresses the second film, creating a depression into which a second composition may then be added, which when sealed with further films, forms a second compartment. The second compartment may comprise a liquid composition or a powder composition. The powder composition may be the same or different than the powder composition in the first compartment. The second compartment may comprise from about 1 g to about 50 g, in another embodiment from about 5 g to about 35 g, in another embodiment from about 1.5 to about 3.0 g, of the composition. After the filling of the second composition, a third film is added to the top of the second composition to form a second compartment, and the first, second, and third films are sealed together to form a water-soluble pouch.

### B. Drum Process

In another embodiment, the pouches are formed by a drum process in which the second compartments of the pouches are formed simultaneously with the first compartments. While the first compartments are created in the same manner as described above, with the first film being suctioned into first cavities located on a horizontal platen, the second compartments are not created by depressing a second film on top of the first powder compositions. Instead, a third film is drawn into separate second cavities located in a suspended, rotating drum that hangs above the horizontal platen.

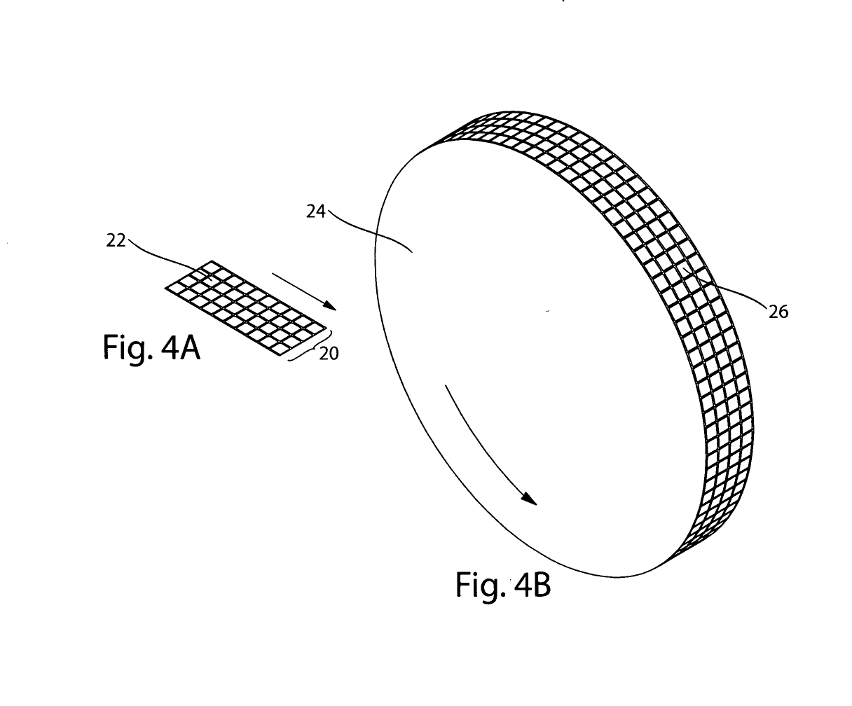

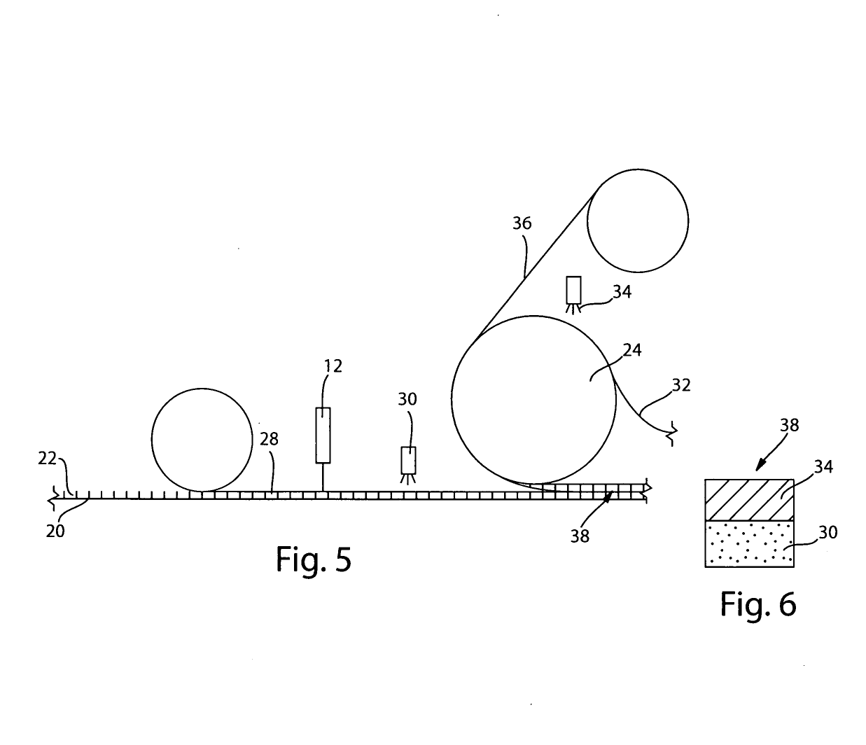

FIG. 4A shows the first cavities 22 on a horizontal platen 20. FIG. 4B shows a rotating drum 24 having second cavities 26. FIG. 5 is an illustration of how pouches are formed by the drum process. A horizontal platen 20 moves the first cavities 22 horizontally where they are contacted by a first film 28 that is suctioned into the first cavities 22. A laser 12 then punctures holes having maximum widths of about 300 μm into the first film 28 in the first cavities 22. A powder composition 30 is placed on top of the first film 28 in the first cavities 22. As this is occurring, second compartments are being formed in a rotating drum 24 having second cavities (26, not shown). As the rotating drum 24 moves, a third film 32 is placed in the second cavities and a liquid composition 34 placed on top of the third film 32 in the second cavities. A second film 36 is then placed on top of the liquid composition 34 in the second cavities, thereby forming preformed second compartments. The rotating drum then deposits the second film 36, being a part of the preformed second compartments, on top of the powder compositions 30 of the first compartments on the horizontal platen 20. The first film 28 and the second film 36 are sealed together to form a pouch 38. FIG. 6 shows a pouch 38 having a top liquid composition 34 and a bottom powder composition 30.

In both processes, further films may be added to the pouch either to form further compartments comprising compositions or to modify the properties of the pouch (e.g. rate of dissolution or robustness of the pouch). In one embodiment, two side-by-side compartments containing either the same, or different, liquid compositions are superposed onto a powder compartment to form a pouch comprising three compartments.

Both processes involve the step of sealing the films together after the second compartments have been formed and, if necessary, filled. If further films have been added, all of the films are sealed together. The sealing can be achieved by conventional means such as heat-sealing but, in one embodiment, may be achieved by solvent-welding. As used herein the term “solvent-welding” refers to the process of forming at least a partial seal between two or more layers of film material by use of a solvent such as water. This does not exclude the fact that heat and pressure may also be applied to form a seal. Any suitable solvent may be used herein. In one embodiment the solvent has a viscosity in the range of from about 0.5 to 15,000 cps (centipoises), in another embodiment from about 2 to 13,000 cps (measured by DIN 53015 at 20° C.). In one embodiment, solvents for use herein comprise plasticizer, for example 1,2 propanediol, and water. In one embodiment, the sealing process involves applying solvent comprising plasticizer to the film and then applying heat and/or pressure. The temperature may be from about 20° C. to about 250° C., in another embodiment from about 23° C. to about 100° C. The pressure may be from about 10 Nm⁻² to 1.5×10⁷ Nm ⁻², in another embodiment about 100 Nm⁻² to 1×10⁵ Nm⁻².

In one embodiment, the process for the production of water-soluble pouches comprises the steps of:
(a) suctioning a first water-soluble film into a first cavity and laser puncturing at least one hole into said first water-soluble film, the laser having a power of from about 0.5 watts to about 20 watts;
(b) adding a powder composition to said first water-soluble film in said first cavity;
(c) contacting a second water-soluble film with said first water-soluble film filled with the powder composition to form a first compartment; and
(d) sealing the first water-soluble film and second water-soluble film together to form a water-soluble pouch.

In another embodiment, the process is an all-in-one process and comprises the steps of:
(a) first suctioning a first film into a cavity to form the bottom of a first compartment and then laser puncturing at least one hole into the first film;
(b) secondly adding a powder composition to said first film;
(c) thirdly drawing a second film onto said powder composition to form a first compartment;
(d) fourthly adding a second composition onto said second film;
(e) fifthly covering the second composition with a third film; and
(f) sealing the first, second, and third films together to form a water-soluble pouch.

In a further embodiment, the process is a drum process and comprises the steps of:
(a) suctioning a first film into a first cavity on a horizontal platen to form the bottom of a first compartment and then laser puncturing at least one hole into the first film;
(b) adding a powder composition to said first film;
(c) forming a second compartment simultaneously by drawing a third film into a second cavity;
(d) adding either a powder or liquid second composition to the third film;
(e) placing a second film onto the second composition to form a preformed second compartment; and
(f) sealing the preformed second compartment onto the first compartment to form a water-soluble pouch.

In both embodiments, the films can be sealed by heat-sealing or by solvent-welding. In both embodiments, the unformed films or the pouches may optionally be dusted or coated with an anti-tacking coating to prevent the films from sticking together.

### Film Material

The film used herein comprises materials which undergo a physical change in water. When formed into pouches, these films release their contents when placed in water. The pouches may undergo such physical changes as breaking apart at the seams, fragmenting, fully dissolving, and any other physical change known in the art to occur with these materials. In one embodiment, the film is water-soluble. “Water-soluble” herein refers to materials that fully dissolve when submerged in water, and also materials that are water-dispersible. Water-soluble films are polymeric materials, specifically polymers which are formed into a film or sheet. The material in the form of a film can, for example, be obtained by casting, blow-molding, extrusion or blow extrusion of the polymer material, as known in the art. The water-dispersible material herein has a dispersability of at least 50%, in another embodiment at least 75% or even at least 95%, as measured by the method set out hereinafter using a glass-filter with a maximum pore size of 50 μm.

The method for determining the water-solubility or water-dispersability of the film material is as follows:

Three test samples are cut from the substrate to be tested (“sample”) using a template to ensure that the sample fits within a 35 mm slide mount with open area dimensions 24×36 mm The samples are cut from areas of the dissolvable substrate equally spaced along the transverse direction of the dissolvable film substrate. As one of ordinary skill in the art would know, the basis weight of the sample is measured and the sample weight is determined by utilizing the open area dimensions. Each of the three samples are locked in a separate 35 mm slide mount. A magnetic stirring rod is placed into a 600 mL beaker, and the beaker filled with 500 mL of city water. The city water is adjusted to reach testing temperature, specifically 5° C. Next, the beaker is placed on the magnetic stirrer, and the speed adjusted until a vortex develops in the water and the bottom of the vortex is at the 400 mL mark on the 600 mL beaker.

The 35 mm slide mount is lowered into the water and positioned in the beaker using a holder designed to hold the sample in place, for example, an alligator clamp. The slide mount should be parallel to the surface of the water in the beaker. This should set up the film perpendicular to the flow of the water. A slightly modified version of this arrangement can be found in FIGS. 1-3 of U.S. Pat. No. 6,787,512.

As soon as the film is submerged in the water such that the entire surface area of the film is contacted by water, the timer is started. Water-solubility occurs when all of the film is no longer visible within the water. Water-dispersability occurs when the film breaks apart. Each solubility and dispersability time is normalized by the weight of the sample to obtain values of the solubility and dispersability times per gram of sample tested, which is in units of seconds/gram of sample (s/g). The average solubility and dispersability times are recorded for each sample.

The polymer can have any weight average molecular weight, in one embodiment from about 1000 to about 1,000,000; in another embodiment from about 10,000 to about 300,000; in another embodiment from about 15,000 to about 200,000; and in a final embodiment from about 20,000 to about 150,000.

Film materials are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. In one embodiment, the polymer is selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, polyvinyl alcohol copolymers and hydroxypropyl methyl cellulose (HPMC), and mixtures thereof. In one embodiment, the level of a type of polymer (e.g., commercial mixture) in the film material, for example PVA polymer, is at least 60% by weight of the film. In one embodiment, the water-soluble film is selected from the group consisting of polyvinyl alcohols, polyvinyl alcohol copolymers, hydroxypropyl methyl cellulose, and mixtures thereof.

Pouches may also comprise compartments formed from different polymers. This may be beneficial to control the mechanical and/or dissolution properties of the compartments of the pouch. For example, one polymer may be present in a first compartment whereas a different, second polymer may be present in a second compartment. In one embodiment, the polymer material for the first compartment has a higher water-solubility than the polymer material for the second compartment; in another embodiment, the polymer material for the first compartment has a higher mechanical strength than the polymer material for the second compartment.

Also useful are polymer blend compositions, for example comprising hydrolytically degradable and water-soluble polymer blends such as polylactide and polyvinyl alcohol, achieved by mixing polylactide and polyvinyl alcohol. In one embodiment, the polymer blend comprises from about 1% to about 35% by weight of polylactide, and approximately from about 65% to about 99% by weight of polyvinyl alcohol.

In one embodiment, the water-soluble films are films which comprise PVA polymers and that have similar properties to the films known under the trade reference M8630, as sold by MonoSol of Merrillville, Ind., US and also PT-75, as sold by Aicello of Japan.

The water-soluble films herein may comprise other additive ingredients. For example, it may be beneficial to add plasticizers, for example glycerol, ethylene glycol, diethylene glycol, propylene glycol, sorbitol and mixtures thereof, and additional water and disintegrating aids. It may also be useful that the water-soluble film itself comprises a detergent additive to be delivered to the wash water, for example, organic polymeric soil release agents, dispersants, and dye transfer inhibitors.

### Compositions

The pouches of the present invention may comprise a variety of compositions. In embodiments having two or more compartments, the first and second compartments may comprise the same composition; in another embodiment may comprise different compositions. In one embodiment, the composition in the first laser punctured compartment is a powder composition and the composition in the second non-laser punctured compartment is a liquid composition. In another embodiment, both the first and second compartments are laser punctured and contain powder compositions. Unless stated otherwise, all percentages herein are calculated based on the total weight of the all the compositions in the pouches, but excluding the film.

The compositions may be cleaning compositions such as automatic dishwashing compositions or fabric care compositions. Automatic dishwashing compositions may include pre-treatment or soaking compositions and other rinse additive compositions. The composition can be in any suitable form such as a liquid, a gel, a solid, or a powder (compressed or uncompressed). In one embodiment, the first compartment comprises a solid or a powder while the second compartment comprises a liquid or a gel. The composition(s) may comprise up to about 15% by weight water. In one embodiment, the compositions comprise less than about 10%, in another embodiment from about 1% to about 8%, in another embodiment from about 2% to about 7.5%, by weight water. This is on the basis of free water, added to the other ingredients of the composition.

The compositions may be made by any method, and can have any viscosity, typically depending on its ingredients. The liquid/gel compositions have a viscosity of from about 50 to about 10000 cps, as measured at a rate of 20 s⁻¹, in another embodiment from about 300 to about 3000 cps, or even from about 150 to about 300 cps. The compositions herein can be Newtonian or non-Newtonian. The liquid composition has a density of 0.8 kg/l to 1.3 kg/l, in another embodiment from about 1.0 to 1.1 kg/l.

In one embodiment of the compositions herein, at least a surfactant and builder are present for increased cleaning. Surfactants may be selected from the group consisting of anionic, amphoteric, zwitterionic, nonionic (including semi-polar nonionic surfactants), cationic surfactants and mixtures thereof. In one embodiment, the surfactant is an ionic and anionic surfactant mixture. The compositions may have a total surfactant level of from about 0.5% to about 75% by weight, in another embodiment from about 1% to about 50% by weight, and in another embodiment from about 5% to about 30% by weight of the total composition. In one embodiment, the composition comprises an anionic surfactant. These can include salts (including, for example, sodium, potassium, ammonium, and substituted ammonium salts such as mono-, di- and triethanolamine salts) of the anionic sulfate, sulfonate, carboxylate and sarcosinate surfactants. Other anionic surfactants include the isethionates such as the acyl isethionates, N-acyl taurates, fatty acid amides of methyl tauride, alkyl succinates and sulfosuccinates, monoesters of sulfosuccinate (especially saturated and unsaturated C12-C18 monoesters) diesters of sulfosuccinate (especially saturated and unsaturated C6-C14 diesters), N-acyl sarcosinates. Resin acids and hydrogenated resin acids are also suitable, such as rosin, hydrogenated rosin, and resin acids and hydrogenated resin acids present in or derived from tallow oil.

The compositions may comprise a water-soluble builder compound, typically present in detergent compositions at a level of from about 1% to about 60% by weight of the composition, in another embodiment from about 3% to about 40% by weight, and in another embodiment from about 5% to about 25% by weight of the composition.

Suitable water-soluble builder compounds include the water soluble monomeric carboxylates, or their acid forms, or homo or copolymeric polycarboxylic acids or their salts in which the polycarboxylic acid comprises at least two carboxylic radicals separated from each other by not more than two carbon atoms, and mixtures of any of the foregoing. Builder compounds may be selected from the group consisting of citrate, tartrate, succinates, oxydissuccinates, carboxymethyloxysuccinate, nitrilotriacetate, and mixtures thereof.

In one embodiment, one or more fatty acids and/or optionally salts thereof (such as sodium salts) are present in the composition. It has been found that this can provide further improved softening and cleaning of the fabrics. The compositions may contain about 1% to about 25% by weight of a fatty acid or salt thereof, in another embodiment from about 6% to about 18% or even from about 10% to about 16% by weight of the composition. In one embodiment, the composition comprises C12-C18 saturated and/or unsaturated, linear and/or branched, fatty acids. In another embodiment, the composition comprises a mixture of saturated and unsaturated fatty acids, for example a mixture of rape seed-derived fatty acid and C16-C18 topped whole cut fatty acids, or a mixture of rape seed-derived fatty acid and a tallow alcohol derived fatty acid, palmitic, oleic, fatty alkylsuccinic acids, and mixtures thereof. In one embodiment, anionic surfactant and water-soluble builder are present, and the water-soluble builder is a fatty acid builder.

The compositions herein may contain a partially soluble or insoluble builder compound, typically present in compositions at a level of from about 0.5% to about 60% by weight, in another embodiment from about 5% to about 50% by weight, in another embodiment from about 8% to about 40% weight of the composition. In one embodiment, the insoluble builder is an aluminosilicates and/or crystalline layered silicates such as SKS-6, available from Clariant.

The composition may also comprise enzymes and a bleaching system. Suitable enzymes include enzymes selected from the group consisting of peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, and mixtures thereof. Detergent compositions generally comprise a cocktail of applicable enzymes like protease, amylase, cellulase, lipase, and mixtures thereof.

The compositions may comprise a bleaching system, such as a perhydrate bleach system. Examples of prehydrate bleaches include salts of percarbonates, particularly the sodium salts, and/or organic peroxyacid bleach precursor, and/or transition metal bleach catalysts, especially those comprising Mn or Fe. It has been found that when the pouch is formed from a material with free hydroxy groups, such as PVA, the bleaching agent comprises a percarbonate salt and is free from any perborate salts or borate salts. It has been found that borates and perborates interact with these hydroxy-containing materials and reduce the dissolution of the materials and also result in reduced performance. Inorganic perhydrate salts are a source of peroxide. Examples of inorganic perhydrate salts include percarbonate, perphosphate, persulfate and persilicate salts. The inorganic perhydrate salts are normally the alkali metal salts. Alkali metal percarbonates, particularly sodium percarbonate, are present perhydrates in one embodiment.

The compositions herein may comprise a peroxy acid or a precursor therefore (bleach activator), in one embodiment comprising an organic peroxyacid bleach precursor. In one embodiment the composition comprises at least two peroxy acid bleach precursors, in one embodiment at least one hydrophobic peroxyacid bleach precursor and at least one hydrophilic peroxy acid bleach precursor, as defined herein. The production of the organic peroxyacid occurs by an in-situ reaction of the precursor with a source of hydrogen peroxide. The hydrophobic peroxy acid bleach precursor may comprise a compound having an oxy-benzene sulphonate group.

Amide substituted alkyl peroxyacid precursor compounds may also be used herein. Suitable amide substituted bleach activator compounds are described in EP-A-0170386.

The compositions may also contain a pre-formed organic peroxyacid. Organic peroxyacids include diacyl and tetraacylperoxides, such as diperoxydodecanedioc acid, diperoxytetradecanedioc acid and diperoxyhexadecanedioc acid. Mono- and diperazelaic acid, mono- and diperbrassylic acid and N-phthaloylaminoperoxicaproic acid are also suitable herein.

In one embodiment, the bleaching agent is a preformed peroxyacid. The composition may also comprise perfume, brightener, buffering agents, fabric softening agents, including clays and silicones benefit agents, suds suppressors, colorant or dye and/or pearlescence agents. In one embodiment, the composition comprises at least a water-soluble builder, surfactant, perfume, enzymes, and bleach.

In one embodiment, wherein the composition is a fabric enhancing composition, the composition comprises at least a perfume and a fabric benefit agent, wherein the fabric benefit agent is either a cationic softening agent or clay softening agent. The fabric enhancing composition may also contain anti-wrinkling agent and/or fabric substantive dye.

The above mentioned compositions may also contain additional solvents, such as alcohols, diols, monoamine derivatives, glycerol, glycols, and polyalkylane glycols, such as polyethylene glycol. In one embodiment, the composition comprises mixtures of solvents, such as mixtures of alcohols and diols. In one embodiment, at least an alcohol, diol, monoamine derivative, and glycerol are present in the composition. In one embodiment, the compositions of the invention are concentrated liquids having less than about 50%, in another embodiment less than about 40%, in another embodiment less than 30%, or even less than 20%, by weight of solvent.

The composition can comprise a cyclic hydrotrope. Any suitable cyclic hydrotrope may be used. In one embodiment, the hydrotropes are selected from the group of salts of cumene sulphonate, xylene sulphonate, naphthalene sulphonate, p-toluene sulphonate, and mixtures thereof. In one embodiment, the sodium form of the hydrotrope is present; in another embodiment, the potassium, ammonium, alkanolammonium, and/or C₂-C₄ alkyl substituted ammonium forms are present.

The compositions herein may contain a C₅-C₂₀ polyol, wherein at least two polar groups are separated from each other by at least 5, in another embodiment at least 6, carbon atoms. In one embodiment, the polyol is a C₅-C₂₀ polyol such as 1,4 Cyclo Hexane Di Methanol, 1,6 Hexanediol, 1,7 Heptanediol, and mixtures thereof.

The compositions herein may also comprise perfume. In one embodiment, the compositions comprise perfume components, wherein at least one component comprises a coating agent and/or carrier material. In one embodiment, organic polymer carries the perfume or an aluminosilicate carries the perfume, or an encapsulate encloses the perfume, for example starch or other cellulosic material encapsulate. The compositions of the present invention may comprise from about 0.01% to about 10% of perfume, in another embodiment from about 0.1% to about 3% of perfume. The different compartments herein can comprise different types and levels of perfume.

The compositions herein may comprise fabric softening clays. Fabric softening clays are smectite clays, which can also be used to prepare the organophilic clays described hereinafter, for example as disclosed in EP-A-299575 and EP-A-313146. Specific examples of suitable smectite clays are selected from the classes of the bentonites—also known as montmorillonites, hectorites, volchonskoites, nontronites, saponites and sauconites, particularly those having an alkali or alkaline earth metal ion within the crystal lattice structure. In one embodiment, the fabric softening clay is a hectorite. Examples of hectorite clays suitable for the present compositions include Bentone EW, as sold by Elementis.

The clay may also be an organophilic clay, such as a smectite clay, whereby at least 30%, in another embodiment at least 50%, in another embodiment at least 60%, of the exchangeable cations in the clay are replaced by a long-chain, organic cation. Such clays are also referred to as hydrophobic clays. The cation exchange capacity of clays and the percentage exchange of the cations with the long-chain organic cations can be measured in several ways known in the art, as for example fully set out in Grimshaw, The Chemistry and Physics of Clays, Interscience Publishers, Inc.,pp. 264-265 (1971). In one embodiment the composition comprises organophilic clays as available from Rheox/Elementis, such as Bentone SD-1 and Bentone SD-3, which are registered trademarks of Rheox/Elementis.

The compositions herein are not formulated to have an unduly high pH. In one embodiment, the compositions of the present invention have a pH, measured as a 1% solution in distilled water, of from about 7.0 to about 12.5, in another embodiment from about 7.5 to about 11.8, and in another embodiment from about 8.0 to about 11.5.

### Pouches

The pouches herein can be of any form suitable to hold the compositions, e.g. without allowing the substantial release of composition from the pouch prior to use. The exact execution will depend on, for example, the type and amount of the composition in the pouch, the number of compartments in the pouch, the characteristics required from the pouch to hold, protect, and deliver or release the compositions. The pouch may be of any suitable size but should conveniently contain either a unit dose amount of the composition herein, suitable for the required operation, for example one wash, or only a partial dose, to allow the consumer greater flexibility to vary the amount used, for example depending on the size and/or degree of soiling of the wash load.

In one embodiment, the pouches comprise one powder compartment. In another embodiment, the pouches comprise at least two compartments to form multi-compartment unit dose pouches, at least one compartment comprising a powder. In one embodiment, the two compartments are superposed to one another. In one embodiment, at least one of the compartments contains a liquid detergent composition and at least one separate compartment contains a powder detergent composition.

### EXAMPLES

### Example 1

Samples of MonoSol M8630® film, a PVA film, are punctured with a Synrad 48-1 10 watt CO₂ laser under the following conditions:
   The PVA film is moving in relation to the laser, with the laser having a pulse of from about 400 μs to about 1000 μs;
   The laser beam is about 0.01 mm wide when contacting the film; and
   The tip of the laser is no closer than 25 mm from the top of the film adjacent to the cavities.

### The Results Show:

A 450 μs pulse laser at 10 watts yields a 0.08×0.08 mm hole;
A 600 μs pulse laser at 10 watts yields a 0.13×0.11 mm hole;
A 750 μs pulse laser at 10 watts yields a 0.17×0.11 mm hole;
A 900 μs pulse laser at 10 watts yields a 0.2×0.15 mm hole.
It can be noted that the fastest pulse yields the smallest and most circular hole. As the pulse length increases, the size of the hole increases and becomes elongated in relation to the moving film.

### Example 2

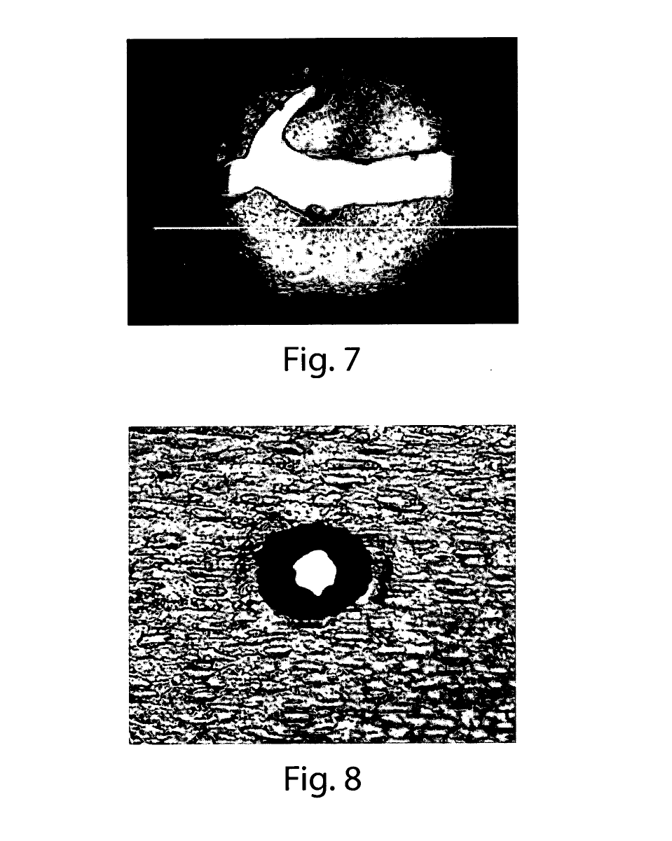

The size of these holes can be compared to a traditionally needle punctured pouch using an existing mechanical needle, moving at the same film speed, as seen in FIG. 7.
FIG. 7 shows the prior art, specifically, a mechanically needle punctured hole having, on average, an area of about 1.18×0.335 mm as measured by a digital microscope (Zeiss Stemi SV11 Ser. No. 455056) attached to a Sony Camera (3-CCD Model DXC-760MD) and a computer using Image Pro Plus 7.0.
The hole in FIG. 7 sees extreme elongation in the direction of film travel. This is due to the needle moving relative to the direction of film travel as it engages the hole, essentially “dragging” a hole in the film which is typically referred to as a “tear” in the film. This is in contrast to the substantially circular hole shown in FIG. 8 which is formed by a laser.

TABLE 1
A results of various puncturing methods

| | | | | Percent area of |
|---|---|---|---|---|
| | | | | laser hole to |
| | | | | area of current |
| | | | Approximate | pin punctured |
| Method | Length | Width | Area | hole size |
| Mechanical | 1.18 mm | 0.335 mm | 0.39 mm² | 100% |
| Laser at 900 μs | 0.2 mm | 0.15 mm | 0.025 mm² | 6% |
| Laser at 750 μs | 0.17 mm | 0.11 mm | 0.015 mm² | 4% |
| Laser at 600 μs | 0.13 mm | 0.11 mm | 0.011 mm² | 3% |
| Laser at 450 μs | 0.08 mm | 0.08 mm | 0.005 mm² | 1% |

Table 1 shows that the laser is capable of delivering hole sizes that have areas which are as small as approximately 1% of the smallest hole size typical formed by a mechanical needle puncturing process.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for making a hole in a pouch, the process comprising:
(a) providing a film;
(b) directing a laser beam from a laser to a portion of said film to form a hole having a maximum width of from about 0.5 μm to about 300 μm, the laser having a power of from about 0.5 watts to about 20 watts; and
(c) incorporating said film with said hole into a pouch.

2. The process according to claim 1, wherein the pouch comprises at least one compartment containing a powder composition in contact with the film having the hole.

3. The process according to claim 2, wherein the pouch is a multi-compartment pouch comprising at least one compartment containing a liquid composition in contact with a film not having any holes, and at least one separate compartment containing a powder composition in contact with the film having the hole.

4. The process according to claim 3, wherein the tip of the laser beam is at least 25 mm away from the top of the film.

5. The process according to claim 1, wherein the hole has an area of about 0.001 mm² to about 0.2 mm².

6. The process according to claim 1, wherein the film is moving at a processing speed and the laser beam is pulsing, the film speed and the pulsing being coordinated to form a hole that is substantially circular.

7. The process according to claim 6, wherein the film is water-soluble and is selected from the group consisting of polyvinyl alcohols, polyvinyl alcohol copolymers, hydroxypropyl methyl cellulose, and mixtures thereof.

8. A process for manufacturing a pouch, said process comprising:
(a) providing a film;
(b) directing a laser beam from a laser to a portion of said film to form a hole, the laser having a power of from about 0.5 watts to about 20 watts, the laser emitting a laser beam through a lens; and
(c) incorporating the film with the hole into a pouch.

9. The process according to claim 8, wherein the lens comprises glass.

10. The process according to claim 9, wherein the lens is a hollow tube about 40 mm wide and about 80 mm long.

11. The process according to claim 9, wherein the at least one hole has a size of from about 0.5 μm to about 300 μm.

12. A process for manufacturing a pouch, said process comprising the steps of:
(a) suctioning a first film into a first cavity and laser puncturing at least one hole into said first film, the laser having a power of from about 0.5 watts to about 20 watts;
(b) adding a powder composition to said first film in said first cavity;
(c) contacting a second film with said first film to form a first compartment; and
(d) sealing the first film and second film together to form a pouch.

13. The process according to claim 12, further comprising the steps of suctioning the second film onto the powder composition in the first cavity and then adding a second composition to said second film.

14. The process according to claim 13, wherein the second composition is a liquid detergent composition.

15. The process according to claim 13, further comprising the steps of contacting a third film with said second film to form a second compartment, and wherein further said first, second, and third films are sealed to form a multi-compartment pouch.

16. The process according to claim 12, wherein the second film is part of a preformed second compartment.

17. The process according to claim 16, wherein said preformed second compartment is produced by a process comprising the steps of: drawing a third film into a second cavity; adding a second composition to said third film in said second cavity; contacting the second film with said third film; and sealing the third and second films to form the preformed second compartment.

18. The process according to claim 17 wherein the second composition is a liquid detergent composition and wherein further said second and third films do not comprise any holes.

19. The process according to claim 12, wherein the laser is a CO₂ laser.

20. The process according to claim 12, wherein the at least one hole has a maximum width of from about 0.5 μm to about 300 μm.
